(19) United States
(12) Patent Application Publication
(10) Pub. No.: US 2008/0296892 A1
(43) Pub. Date: Dec. 4, 2008

(54) Extendable pipe union

(76) Inventor: Dimitre Cheytanov, Chicago, IL (US)

Correspondence Address: DIMITRE CHEYTANOV, 4725 North Kasson Avenue, # 3, Chicago, IL, 60630, US

(21) Appl. No.: 11/809,245

(22) Filed: May 31, 2007

(51) Int. Cl. F16L 27/04

(52) U.S. Cl. 285/136.1

(57) ABSTRACT

A pipe union for interconnecting a first length and a second length of pipe, may include a first annular pipe member attachable to the first length of pipe. The first annular pipe member may have threading means formed on an inner surface of the first annular pipe member. The pipe union may also include a second annular pipe member attachable to the second length of pipe. The second annular pipe member may have threading means formed on an outer surface, which may be adapted to engage the threading means on the inner surface of the first annular pipe member. The pipe union may also include a third annular pipe member disposed between the first and second annular pipe members. The threading means on the inner surface of the first pipe member may engage threading means on an outer surface of the first length of pipe.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to plumbing parts. More specifically, certain embodiments of the invention relate to an extendable pipe union.

### BACKGROUND OF THE INVENTION

Pipe unions are widely utilized for interconnecting separate lengths of pipes or other conduit. For example, a pipe union may be utilized to connect two separate long runs of pipe. In addition, a pipe union may be utilized to repair a break, or rupture, in a given run of pipe. In such instances, a short length of the ruptured pipe may be removed so that the break or rupture may be repaired. The resulting two lengths of pipe may then be connected via a pipe union.

FIG. 1 is a partial cross-sectional view of a prior art pipe union. Referring to FIG. 1, the pipe union 100 comprises a first annular pipe member 104, a second annular pipe member 102, and a fastening member 106. The first annular pipe member 104 may be adapted to receive a length of pipe 110 and the second annular pipe member 102 may be adapted to receive a length of pipe 108. For example, the annular pipe members 104 and 102 may comprise internal thread means and may be adapted to engage externally-threaded lengths of pipe 110 and 108, respectively, utilizing the thread means. In addition, the annular pipe members 104 and 102 may be welded to corresponding ends of pipes 110 and 108, respectively.

The fastening member 106 may comprise an inwardly extending flange 107. During an installation of the pipe union 100, the annular pipe members 104 and 102 may be attached to the corresponding lengths of pipe 110 and 108, respectively (e.g., by utilizing thread means or welding). The fastening member may be slided over the first annular pipe member 104 so that the inwardly extending flange 107 abuts a shoulder 109 of an extending flange of the first annular pipe member 104. The pipes 110 and 108 may be brought together and the pipe union 100 may be closed by engaging the thread means on the fastening member with the thread means on the second annular pipe member 102. The pipe union 100 may be engaged by tightening the fastening member 106 so that a concave surface from the circumferential area 112 in the second annular pipe member 102 abuts a convex surface of the first annular pipe member 104, as illustrated in area 114 in FIG. 1.

Referring again to FIG. 1, in order to attach the annular pipe members 104 and 102 to the pipes 110 and 108, one of the pipes, either 108 or 110, must be moved aside so that there may be enough space to install the pipe members 104 and 102 to the corresponding pipes 110 and 108. After the pipe members 104 and 102 are installed, the pipe which was moved during the installation of the pipe members may be moved back to its original position so that the two lengths of pipe 110 and 108 are coaxial.

A drawback, therefore, exists with regard to using prior art pipe unions, such as pipe union 100, as it is undesirable, or impossible under certain circumstances, to move either pipe 110 or 108 in order to install the pipe union 100. The present invention discloses a solution allowing for installation of a pipe union without moving any of the pipes intended for connection by the pipe union. Furthermore, the present invention discloses a solution allowing for installation of a pipe union that interconnects lengths of pipe or conduit of different diameters, or lengths of pipe or conduit that are disposed at an angle relative to each other (i.e., the lengths of pipe are not coaxial), without moving any of the pipes intended for connection by the pipe union.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

In an exemplary aspect of the invention, a pipe union for interconnecting a first length and a second length of pipe may comprise a first annular pipe member attachable to the first length of pipe. The first annular pipe member may have a front face which faces the first length of pipe and a rear face which faces in a direction of the second length of pipe. The first annular pipe member may have threading means formed on an inner surface of the first annular pipe member.

The pipe union may further comprise a second annular pipe member attachable to the second length of pipe. The second annular pipe member may have a rear face which faces the second length of pipe, and a front face which faces in a direction of the first length of pipe. The second annular pipe member may have first threading means formed on an outer surface of the second annular pipe member, and second threading means formed on an inner surface of the second annular pipe member. The first threading means of the second annular pipe member may be adapted to engage the threading means on the inner surface of the first annular pipe member so that at least a portion of the outer surface of the second annular pipe member is rotatable against at least a portion of the inner surface of the first annular pipe member.

The pipe union may further comprise a third annular pipe member. The third annular pipe member may have a rear face which faces the second length of pipe, and a front face which faces in a direction of the first length of pipe. The third annular pipe member may have threading means formed on an inner surface of the third annular pipe member. The threading means on the inner surface of the third annular pipe member may be adapted to engage at least a portion of the first threading means on the outer surface of the second annular pipe member, so that the third annular pipe member is disposed between the first and second annular pipe members.

The threading means on the inner surface of the first annular pipe member may be adapted to engage threading means on an outer surface of the first length of pipe. The second threading means on the inner surface of the second annular pipe member may be adapted to engage threading means on an outer surface of the second length of pipe. The threading means on the inner surface of the first annular pipe member may occupy substantially the entire the inner surface. The threading means on the inner surface of the first annular pipe member may comprise a first threading means portion and a second threading means portion.

The first threading means portion and the second threading means portion may be separated by an unthreaded portion of the inner surface of the first annular pipe member. The first threading means portion on the inner surface of the first annular pipe member may be adapted to engage threading means on an outer surface of the first length of pipe. The second threading means portion on the inner surface of the first annular pipe member may be adapted to engage the first threading means on the outer surface of the second annular pipe member. The threading means on the inner surface of the first annular pipe member engages the first length of pipe, while the second threading means on the inner surface of the second annular pipe member engages the second length of pipe, thereby increasing the length of the pipe union.

The third annular pipe member may be adapted to lock movement of the first threading means on the outer surface of the second annular pipe member in relation to the threading means on the inner surface of the first annular pipe member. The third annular pipe member may be adapted to lock the movement by rotating the third annular pipe member around the second annular pipe member and engaging the front face of the third annular pipe member against the rear face of the first annular pipe member. The first annular pipe member may comprise a tee joint, a cross joint, and/or an elbow joint.

The third annular pipe member may also be adapted to tighten the connections between the first annular pipe member and the first length of pipe, and between the second annular pipe member and the second length of pipe. In this regard, the connection tightening may be achieved by rotating the third annular pipe member around the second annular pipe member and engaging the front face of the third annular pipe member against the rear face of the first annular pipe member.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a partial cross-sectional view of a prior art pipe union.

FIG. 1A is a partial cross-sectional view of an extendable pipe union in a collapsed state, in accordance with an embodiment of the invention.

FIG. 2 is a partial cross-sectional view of the extendable pipe union of FIG. 1A in extended form, in accordance with an embodiment of the invention.

FIG. 3A is an extendable pipe union implemented with a tee joint, in accordance with an embodiment of the invention.

FIG. 3B is an extendable pipe union implemented with a cross joint, in accordance with an embodiment of the invention.

FIG. 4A is an extendable pipe union implemented with a 90-degree elbow joint, in accordance with an embodiment of the invention.

FIG. 4B is an extendable pipe union implemented with an angled elbow joint, in accordance with an embodiment of the invention.

FIG. 5 is an extendable pipe union for interconnecting pipes with different diameters, in accordance with an embodiment of the invention.

### DETAILED DESCRIPTION OF THE INVENTION

Certain aspects of the invention may be found in an extendable pipe union for attaching a first and a second length of pipe. In an exemplary aspect of the invention, the pipe union may comprise three annular pipe members. For example, the first annular pipe member may have a front face which faces the first length of pipe and a rear face which faces in a direction of the second length of pipe. The first annular pipe member ma have threading means formed on an inner surface of the first annular pipe member. The threading means may be disposed on the entire length of the inner surface, or the threading means may be formed on both sides of the inner surface of the first annular pipe member, thereby being separated by a smooth surface (i.e., a surface without threading).

The pipe union's second annular pipe member may be attachable to the second length of pipe via threading means disposed on an inner surface of the second annular pipe member. In addition, the second annular pipe member may include threading means disposed on an outer surface of the second annular pipe member so that the second annular pipe member may be threaded in and out of the first annular pipe member, using the threading on the inner surface of the first annular pipe member.

The pipe union's third annular pipe member may have a rear face which faces the second length of pipe, and a front face which faces in a direction of the first length of pipe. The third annular pipe member may have threading means formed on an inner surface of the third annular pipe member, and may be disposed between the first and second annular pipe members. The third annular pipe member may be used as a locking collar to lock movement of the second annular pipe member in relation to the first annular pipe member. For example, once the second annular pipe member is rotated in or out of the first annular pipe member so that the two lengths of pipe are engaged by the first annular pipe member and the second annular pipe member, then the third annular pipe member may be rotated against the outer surface threading means of the second annular pipe member until the front face of third annular pipe member, which faces the first length of pipe, abuts the rear face of the first annular pipe member.

At the moment when the third annular pipe member abuts the first annular pipe member, any further rotation and movement of the second annular pipe member may be prevented. The third annular pipe member may also be adapted to tighten the connections between the first annular pipe member and the first length of pipe, and between the second annular pipe member and the second length of pipe. In this regard, the connection tightening may be achieved by rotating the third annular pipe member around the second annular pipe member and engaging the front face of the third annular pipe member against the rear face of the first annular pipe member.

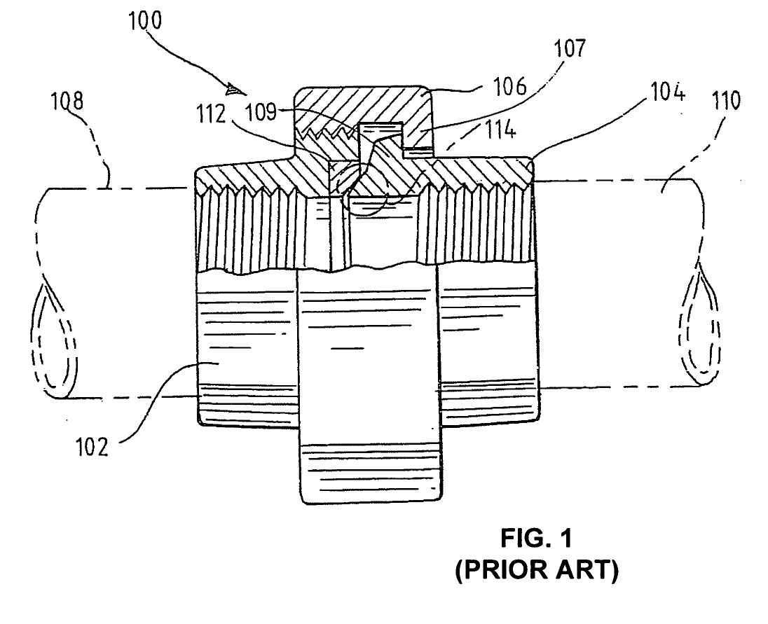

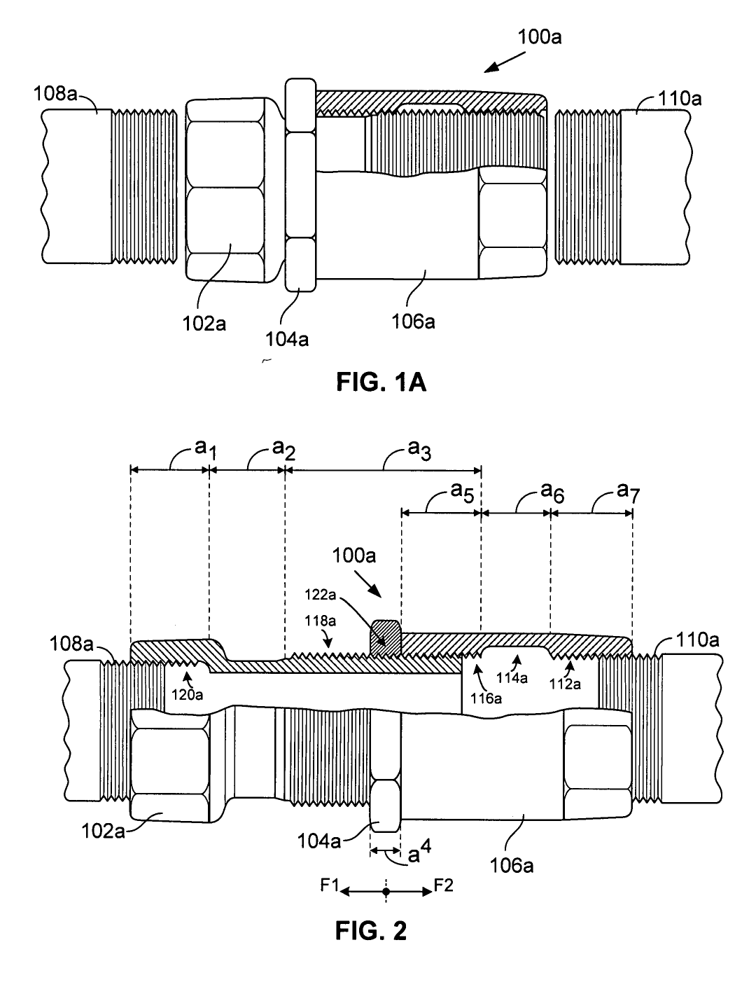

FIG. 1A is a partial cross-sectional view of an extendable pipe union in a collapsed state, in accordance with an embodiment of the invention. FIG. 2 is a partial cross-sectional view of the extendable pipe union of FIG. 1A in extended form, in accordance with an embodiment of the invention.

Referring to FIGS. 1A and 2, the extendable pipe union 100a may comprise a first annular pipe member 106a, a second annular pipe member 102a, and a third annular pipe member 104a. The pipe union 100a may be used to interconnect two lengths of pipe—a first length of pipe 110a and a second length of pipe 108a.

The first annular pipe member 106a may have a front face which faces the first length of pipe 110a and a rear face which faces in a direction of the second length of pipe 108a. The first annular pipe member 106a may also have threading means 112a formed on an inner surface of the first annular pipe member 106a.

The pipe union 100a may further comprise a second annular pipe member 102a attachable to the second length of pipe 108a. The second annular pipe member 108a may have a rear face which faces in a direction of the second length of pipe 108a, and a front face which faces in a direction of the first length of pipe 110a. The second annular pipe member may have first threading means 118a formed on an outer surface of the second annular pipe member 102a, and second threading means 120a formed on an inner surface of the second annular pipe member 102a. The first threading means 118a of the second annular pipe member 102a may be adapted to engage the threading means 116a and/or 112a on the inner surface of the first annular pipe member 106a, so that at least a portion of the outer surface of the second annular pipe member 102a is rotatable against at least a portion of the inner surface of the first annular pipe member 106a.

The pipe union 100a may further comprise a third annular pipe member 104a. The third annular pipe member 104a may have a rear face which faces the second length of pipe 108a, and a front face which faces in a direction of the first length of pipe 110a. The third annular pipe member 104a may have threading means 122a formed on an inner surface of the third annular pipe member 104a. The threading means 122a on the inner surface of the third annular pipe member may be adapted to engage at least a portion of the first threading means 118a on the outer surface of the second annular pipe member 102a, so that the third annular pipe member 104a is disposed between the first annular pipe member 106a and the second annular pipe member 102a.

In one embodiment of the invention, the threading means 112a on the inner surface of the first annular pipe member 106a may be adapted to engage threading means on an outer surface of the first length of pipe 110a. The second threading means 120a on the inner surface of the second annular pipe member 102a may be adapted to engage threading means on an outer surface of the second length of pipe 108a. Furthermore, to ensure a tight joint, the threading means on the outer surfaces of the pipes 110a and 108a may be placed so that the threaded surfaces are slightly tilted (or slanted) in an inward direction towards the first and second annular pipe members 106a and 102a, respectively (not shown in FIGS. 1A or 2). For example, a left-most portion of the pipe 110a which is closer to the front face of the first annular pipe member 106a may have a diameter that is slightly smaller than a diameter of a portion of the pipe 110a where the threading ends and the unthreaded portion of pipe 110a begins.

In one embodiment of the invention, the threading means on the inner surface of the first annular pipe member 106a may occupy substantially the entire the inner surface. In another embodiment of the invention, the threading means on the inner surface of the first annular pipe member may comprise a first threading means portion 112a and a second threading means portion 116a. The first threading means portion 112a and the second threading means portion 116a may be separated by an unthreaded portion 114a of the inner surface of the first annular pipe member 106a. The first threading means portion 112a on the inner surface of the first annular pipe member 106a may be adapted to engage threading means on an outer surface of the first length of pipe 110a (as shown in FIG. 2). The second threading means portion 116a on the inner surface of the first annular pipe member 106a may be adapted to engage the first threading means 118a on the outer surface of the second annular pipe member 102a. The first threading means portion 112a on the inner surface of the first annular pipe member 106a engages the first length of pipe, while the second threading means 120a on the inner surface of the second annular pipe member 102a engages the second length of pipe 108a.

In this regard, after the pipe union 100a is inserted in a collapsed form between the pipes 110a and 108a (as shown in FIG. 1A), the first annular pipe member 106a may be threaded on to the first length of pipe 110a, and the second annular pipe member 102a may be rotated out of the first annular pipe member 106a, thereby threading the second annular pipe member on to the second length of pipe 108a, and thereby increasing the length of the pipe union 100a (as shown in extended state in FIG. 2).

In one embodiment of the invention, the third annular pipe member 104a may be adapted to lock movement of the first threading means 118a on the outer surface of the second annular pipe member 102a in relation to the threading means 116a on the inner surface of the first annular pipe member 106a. The third annular pipe member 104a may be adapted to lock the movement by rotating the third annular pipe member 104a around the second annular pipe member 102a (using the threading means 118a and 122a) and engaging the front face of the third annular pipe member 104a against the rear face of the first annular pipe member 106a.

In one embodiment of the invention, the third annular pipe member 104a may also be adapted to tighten the connections between the first annular pipe member 106a and the first length of pipe 110a, and between the second annular pipe member 102a and the second length of pipe 108a. In this regard, the connection tightening may be achieved by rotating the third annular pipe member 104a around the threading means 118a of the second annular pipe member 102a, and engaging the front face of the third annular pipe member 104a against the rear face of the first annular pipe member 106a (as illustrated in FIG. 2). For example, the third annular pipe member 104a may be a locking nut or a locking washer. After the first annular pipe member 106a is tightened against the pipe 110a and the second annular pipe member 102a is tightened against the pipe 108a, the third annular pipe member 104a may be tightened against the rear face of the first annular pipe member 104a. Consequently, pressure is created in two opposite directions towards pipes 110a and 108a, as designated by the pushing forces F1 and F2, illustrated in FIG. 2. In this regard, by tightening the third annular pipe member 104a against the first annular pipe member 106a, after the pipe union 100a is extended into place and connects pipes 110a and 108a, the third annular pipe member 104a may be tightened against the first annular pipe member 106a to ensure tight and secure connections of the first annular pipe member to the pipe 110a and of the second annular pipe member 102a to the pipe 108a.

The invention may not be limited by the individual dimensions of the three annular pipe members 102a, 104a, and 106a. In this regard, different dimensions (such as length and/or diameter) for each of the three annular pipe members 102a, 104a, and 106a may be used. For example, with reference to FIG. 2, the second annular pipe member 102a may utilize threading means 120a with a length a1, a “neck” or unthreaded portion with a length a2, and threading means 118a with length a3. The third annular pipe member 104a may be of width a4. Since the inner threading means 122a run for the entire width of the third annular pipe member 104a, then the length of the threading means 122a may also be a4. Furthermore, as already explained above, the inner surface of the first annular pipe member 106a may comprise a first threading means portion 112a with a length a7, a second threading means portion 116a with a length a5, and an unthreaded (or smooth) portion 114a with a length a6. As already explained above, the threading means on the inner surface of the first annular pipe member 106a may be uninterrupted, i.e., may span for the entire length of the inner surface of the first annular pipe member 106a. In such instances, the entire threading means on the inner surface of the first annular pipe member 106a may be of length that equals (a5+ a6+a7). The parameters a1, . . . , a7 may vary so as to designate different dimensions of the corresponding portions of the three annular pipe members 102a, 104a, and 106a, making the pipe union 100a.

In accordance with various embodiments of the invention, the pipe union 100a may be implemented with a first annular pipe member in different shapes so as to accommodate interconnecting pipes, which are not coaxial, or for interconnecting more than two lengths of pipe.

Referring to FIGS. 1A and 2, during exemplary operation, the pipe union 100a may be used to interconnect pipes 110a and 108a. The second annular pipe member 102a may be initially threaded all the way inside the first annular pipe member 106a, thereby resulting in a collapsed or unextended pipe union 100a, with a minimal length. The unextended pipe union 100a is illustrated in FIG. 1A. After the unextended pipe union 100a is inserted between the pipes 110a and 108a, the first annular pipe member 106a and the second annular pipe member 102a may be rotated in opposite directions so that the first annular pipe member 106a may be threaded on to and tightened around the pipe 110a, the second annular pipe member 102a may be threaded on to and tightened around the pipe 108a. In this regard, the pipe union 100a is extended, as illustrated in FIG. 2. During the threading of the second annular pipe member 102a on to pipe 108a, the third annular pipe member 104a may be threaded along the threading means 118a of the outer surface of the second annular pipe member 102a, so that the third annular pipe member 104a is closer to the rear face of the second annular pipe member 102a and is away from (and is not touching) the rear face of the first annular pipe member 106a.

After the first annular pipe member 106a is tightly threaded on to the pipe 110a and the second annular pipe member 102a is tightly threaded on to the pipe 108a, the third annular pipe member 104a may be threaded back along the threading means 118a, in the direction of the rear face of the first annular pipe member 106a, creating the opposite pushing forces F1 and F2, as explained above. The third annular pipe member 104a may then be tightened against the rear face of the first annular pipe member 106a, to ensure tight, secure and leak-proof connections of the first annular pipe member to the pipe 110a and of the second annular pipe member 102a to the pipe 108a. In this regard, the third annular pipe member may also prevent accidental rotation back of the second annular pipe member 102a into the first annular pipe member 106a, thereby decreasing the length and disengaging the pipe union 100a.

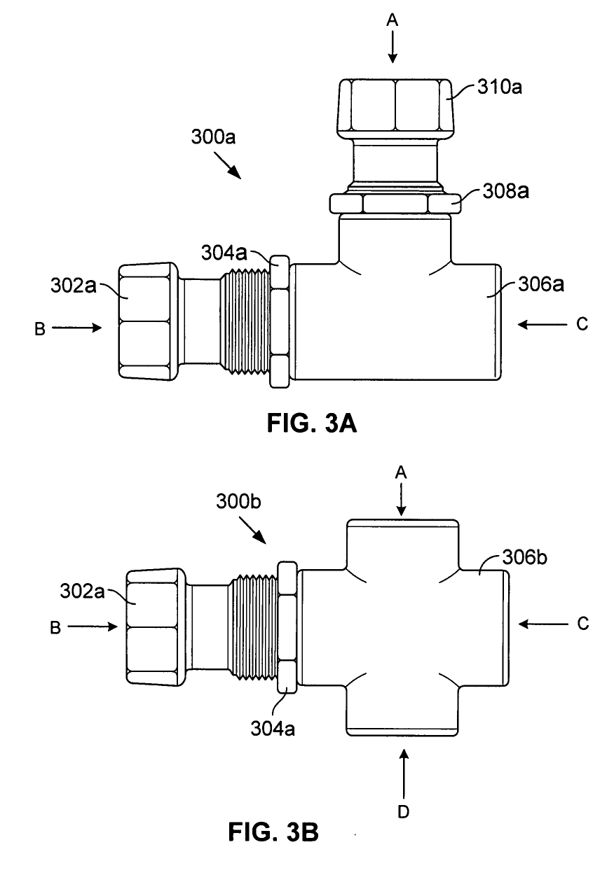

FIG. 3A is an extendable pipe union implemented with a tee joint, in accordance with an embodiment of the invention. Referring to FIG. 3A, the pipe union 300a may comprise a first annular pipe member 306a, a second annular pipe member 302a, and a third annular pipe member 304a. The first annular pipe member 306a, the second annular pipe member 302a, and the third annular pipe member 304a may have the same functionalities as the first annular pipe member 106a, the second annular pipe member 102a, and the third annular pipe member 104a of pipe union 100a, illustrated in FIGS. 1A and 2.

As it is illustrated in FIG. 3A, the first annular pipe member 306a may comprise a tee joint. In this regard, the pipe union 300a may be used to interconnect two or three lengths of pipe, connected at sides A, B and/or C. For example, another set of annular pipe members 310a and 308a may be used to interconnect a pipe from side A. The annular pipe members 310a and 308a may have the same functionalities as the second annular pipe member 302a and the third annular pipe member 304a. In this regard, the annular pipe members 310a and 308a may share the same first annular pipe member 306a body with the second annular pipe member 302a and the third annular pipe member 304a. A similar arrangement (not shown in FIG. 3A) may be used to interconnect a third pipe at side C.

FIG. 3B is an extendable pipe union implemented with a cross joint, in accordance with an embodiment of the invention. Referring to FIG. 3B, the pipe union 300b may comprise a first annular pipe member 306b, a second annular pipe member 302a, and a third annular pipe member 304a. The first annular pipe member 306b, the second annular pipe member 302a, and the third annular pipe member 304a may have the same functionalities as the first annular pipe member 106a, the second annular pipe member 102a, and the third annular pipe member 104a of pipe union 100a, illustrated in FIGS. 1A and 2.

As it is illustrated in FIG. 3B, the first annular pipe member 306b may comprise a cross joint. In this regard, the pipe union 300b may be used to interconnect up to four lengths of pipe, connected at sides A, B, C and/or D. The interconnection of additional annular pipe members is discussed above with regard to FIG. 3A. The same technique with using additional annular pipe members may also be used with the pipe union 300b, so that additional pipes may be interconnected at sides A, C, or D.

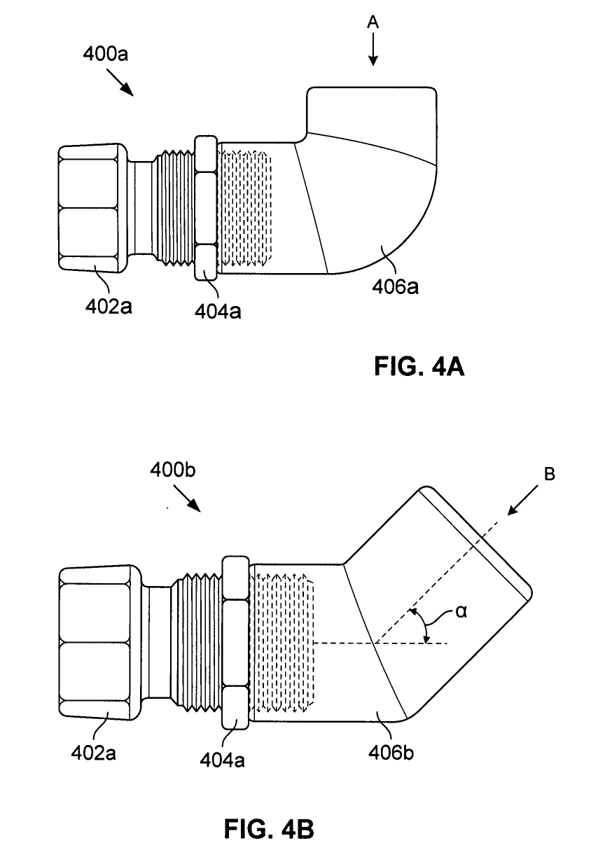

FIG. 4A is an extendable pipe union implemented with a 90-degree elbow joint, in accordance with an embodiment of the invention. Referring to FIG. 4A, the pipe union 400a may comprise a first annular pipe member 406a, a second annular pipe member 402a, and a third annular pipe member 404a. The first annular pipe member 406a, the second annular pipe member 402a, and the third annular pipe member 404a may have the same functionalities as the first annular pipe member 106a, the second annular pipe member 102a, and the third annular pipe member 104a of pipe union 100a, illustrated in FIGS. 1A and 2.

As it is illustrated in FIG. 4A, the first annular pipe member 406a may comprise a 90-degree elbow joint. In this regard, the pipe union 400a may be used to interconnect two pipes which are disposed at a right angle and are not coaxial, such as a pipe connected to the second annular pipe member 402a and another pipe connected from side A.

FIG. 4B is an extendable pipe union implemented with an angled elbow joint, in accordance with an embodiment of the invention. Referring to FIG. 4B, the pipe union 400a may comprise a first annular pipe member 406b, a second annular pipe member 402a, and a third annular pipe member 404a. The first annular pipe member 406b, the second annular pipe member 402a, and the third annular pipe member 404a may have the same functionalities as the first annular pipe member 106a, the second annular pipe member 102a, and the third annular pipe member 104a of pipe union 100a, illustrated in FIGS. 1A and 2.

As it is illustrated in FIG. 4B, the first annular pipe member 406b may comprise an angled elbow joint. More specifically, the angled elbow joint of the first annular pipe member 406b may be adapted to connect pipes which are located at an angle α relative to each other. In this regard, the pipe union 400b may be used to interconnect two pipes which are disposed at an angle relative to each other and are not coaxial, such as a pipe connected to the second annular pipe member 402a and another pipe connected from side B.

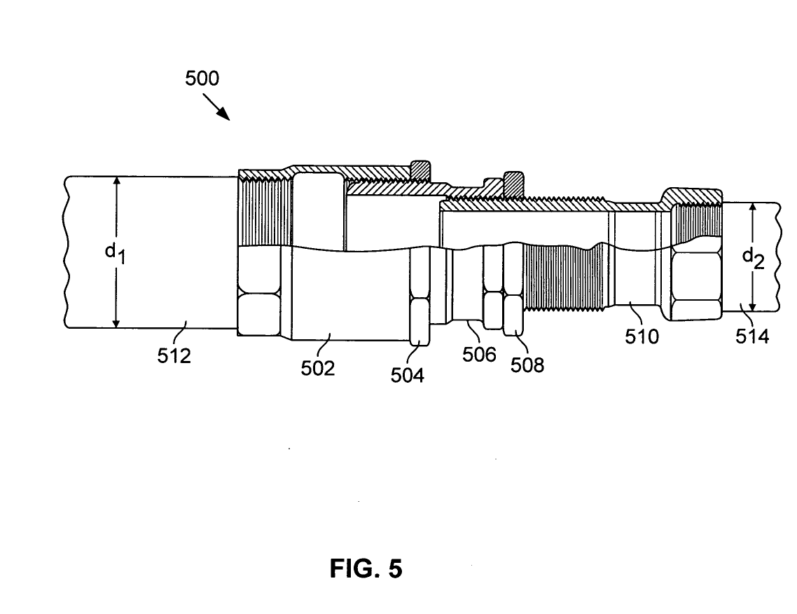

FIG. 5 is an extendable pipe union for interconnecting pipes with different diameters, in accordance with an embodiment of the invention. Referring to FIG. 5, the pipe union 500 may comprise a first annular pipe member 502, a second annular pipe member 510, and a third annular pipe member 504. The first annular pipe member 502 may be used for connecting to a pipe 512 with a diameter d1. The second annular pipe member 510 may be used for connecting to a pipe 514 with a diameter d2, where diameter d1 is different than d2.

The first annular pipe member 502, the second annular pipe member 510, and the third annular pipe member 504 may have the same functionalities as the first annular pipe member 106a, the second annular pipe member 102a, and the third annular pipe member 104a of pipe union 100a, illustrated in FIGS. 1A and 2. As it is illustrated in FIG. 5, the pipe union 500 may also comprise a first additional annular pipe member 506 and a second additional annular pipe member 508. The additional annular pipe members 506 and 508 may have similar functionalities as the first annular pipe member 106a and the third annular pipe member 104a, respectively, as it relates to the annular pipe member 510. In other words, annular members 506, 510 and 508 have the same functionalities as the first annular pipe member 106a, the second annular pipe member 102a, and the third annular pipe member 104a of pipe union 100a, illustrated in FIGS. 1A and 2. The additional annular pipe members 506 and 508 may be used to ensure a smooth transition between the different diameter pipes 512 and 514, as well as tight and leak-proof joints between the elements of the pipe union 500 and the pipes 512 and 514.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A pipe union for interconnecting a first length and a second length of pipe, the pipe union comprising:
a first annular pipe member attachable to the first length of pipe, said first annular pipe member having a front face which faces the first length of pipe and a rear face which faces in a direction of the second length of pipe, and said first annular pipe member having threading means formed on an inner surface of said first annular pipe member;
a second annular pipe member attachable to the second length of pipe, said second annular pipe member having a rear face which faces the second length of pipe and a front face which faces in a direction of the first length of pipe, said second annular pipe member having first threading means formed on an outer surface of said second annular pipe member and second threading means formed on an inner surface of said second annular pipe member, said first threading means of said second annular pipe member adapted to engage said threading means on said inner surface of said first annular pipe member so that at least a portion of said outer surface of said second annular pipe member is rotatable against at least a portion of said inner surface of said first annular pipe member; and
a third annular pipe member, said third annular pipe member having a rear face which faces the second length of pipe and a front face which faces in a direction of the first length of pipe, said third annular pipe member having threading means formed on an inner surface of said third annular pipe member, said threading means on said inner surface of said third annular pipe member adapted to engage at least a portion of said first threading means on said outer surface of said second annular pipe member, so that said third annular pipe member is disposed between said first and second annular pipe members.

2. The pipe union according to claim 1, wherein said threading means on said inner surface of said first annular pipe member are adapted to engage threading means on an outer surface of the first length of pipe.

3. The pipe union according to claim 1, wherein said second threading means on said inner surface of said second annular pipe member are adapted to engage threading means on an outer surface of the second length of pipe.

4. The pipe union according to claim 1, wherein said threading means on said inner surface of said first annular pipe member occupy substantially the entire said inner surface.

5. The pipe union according to claim 1, wherein said threading means on said inner surface of said first annular pipe member comprise a first threading means portion and a second threading means portion.

6. The pipe union according to claim 5, wherein said first threading means portion and said second threading means portion are separated by an unthreaded portion of said inner surface of said first annular pipe member.

7. The pipe union according to claim 5, wherein said first threading means portion on said inner surface of said first annular pipe member is adapted to engage threading means on an outer surface of the first length of pipe.

8. The pipe union according to claim 5, wherein said second threading means portion on said inner surface of said first annular pipe member is adapted to engage said first threading means on said outer surface of said second annular pipe member.

9. The pipe union according to claim 1, wherein said threading means on said inner surface of said first annular pipe member engages said first length of pipe, while said second threading means on said inner surface of said second annular pipe member engages said second length of pipe, thereby increasing the length of the pipe union.

10. The pipe union according to claim 1, wherein said third annular pipe member is adapted to lock movement of said first threading means on said outer surface of said second annular pipe member in relation to said threading means on said inner surface of said first annular pipe member.

11. The pipe union according to claim 10, wherein said third annular pipe member is adapted to lock said movement by rotating said third annular pipe member around said second annular pipe member and engaging said front face of said third annular pipe member against said rear face of said first annular pipe member.

12. The pipe union according to claim 1, wherein said first annular pipe member comprises at least one of the following: a tee joint, a cross joint, and an elbow joint.

13. The pipe union according to claim 1, wherein said third annular pipe member is adapted to tighten connections between said first annular pipe member and said first length of pipe, and between said second annular pipe member and said second length of pipe.

14. The pipe union according to claim 13, wherein said connection tightening is achieved by rotating said third annular pipe member around said second annular pipe member and engaging said front face of said third annular pipe member against said rear face of said first annular pipe member.
